(19) United States
(12) Patent Application Publication
(10) Pub. No.: US 2012/0326973 A1
(43) Pub. Date: Dec. 27, 2012

(54) DISPLAY DEVICE

(75) Inventor: Makoto Kita, Osaka (JP)

(73) Assignee: SHARP KABUSHIKI KAISHA, Osaka (JP)

(21) Appl. No.: 13/581,899

(22) PCT Filed: Jan. 11, 2011
(86) PCT No.: PCT/JP2011/050287

§ 371 Date: Aug. 30, 2012

(30) Foreign Application Priority Data
Mar. 1, 2010 (JP) 2010-044511

(51) Int. Cl. G06F 3/01

(52) U.S. Cl. 345/156

(57) ABSTRACT

A portable phone (100) includes a display panel as a display section (11), a state determining section (2), and an information processing section (3). The state determining section (2) determines that an input button is in an inputted state when an operator's finger or an object is in contact with the input button with a contact area that is at least as large as a prescribed area, determines that the input button is in a semi-inputted state when the operator's finger or the object is in contact with the input button with a contact area that is smaller than the prescribed area, or when a distance between the operator's finger or the object and the input button in a normal direction is no greater than a prescribed distance and the finger or the object is not in contact with the input button, and determines that the input button is in non-inputted state when the operator's finger or the object is away from the input button by a distance in the normal direction that is greater than the prescribed distance. The information processing section (3) performs a function associated with each of the states of the input button, according to the state determined by the state determining section (2).

### TECHNICAL FIELD

The present invention relates to a display device having a touch panel function.

### BACKGROUND ART

In recent years, display devices in which the display section and the input section are combined to make the device compact are in wide use. In particular, the mainstream mobile terminals such as portable phones, PDAs (Personal Digital Assistants), and notebook PCs (personal computer) are those having display devices that can be operated by touching the display screen with a finger, touch pen, or the like.

Such display devices include a touch panel as the input unit. When an operator touches various buttons displayed on the touch panel screen, functions associated with the touched input button is performed. In contrast to hard keys, which are mechanical input buttons provided on a hardware separate from the display section, these input buttons configured by software are called soft keys.

However, such display devices used for small mobile data terminals such as portable phones and PDAs tend to have relatively small display sections. Therefore, various buttons shown on the display screen inevitably become small.

When the touch panel is operated by a finger, for example, if the input buttons displayed are smaller than a finger, identifying the buttons to push becomes difficult. As a result, sometimes the operator is not sure whether the desired button was pushed, and worries that a wrong button near the desired button might have been pushed. This prevents an efficient input operation.

In general, hard key input push buttons on portable phones have protrusions and recesses. An operator identifies the protrusions and recesses of individual input buttons through a touch that is light enough not to cause any input, and then pushes a desired button.

However, input buttons of touch-panel type portable data terminals do not have protrusions and recesses found with hard keys. The operator, therefore, cannot identify the input buttons before pressing them, and has a feeling of uncertainty. This uncomfortable feeling is particularly significant for users with little experience with touch panel operation.

To solve such problems, various proposals have been made.

In Patent Document 1, a technology in which an input is conducted by touching the touch panel with a finger twice is disclosed. According to this technology disclosed in Patent Document 1, the first touch rearranges and magnifies the input buttons near the coordinates of the touch, and the input button of the coordinates of the second touch is determined to be the button that has been pressed.

Disclosed in Patent Documents 2 to 4 is a technology in which, when the touch panel is touched, input buttons near the coordinates of the touch are enlarged, and when the finger is lifted from the panel, input is performed. According to the disclosures in Patent Documents 2 to 4, once the finger is lifted, based on the coordinates data of the last touch and the display position of the input button magnified on the display screen, the input button of the coordinates data of the last touch is determined to be the button that has been pressed.

Patent Document 5 discloses a technology where sensors are disposed in a display input section for detecting locations of a finger or the like. According to this technology, when the location of an operator's finger or an object is detected, a description of the input button on the display panel corresponding to the location, which is the description on the process that will be conducted once the operator touches the input button, is announced by a visual or audio message before the operator actually touches the input button. According to Patent Document 5, a button can be selected and the information of the button can be provided while the button is not touched yet, and once the operator touches the button, the process assigned to the input button is conducted.

### RELATED ART DOCUMENTS

### Patent Documents

Patent Document 1: Japanese Patent Application Laid-Open Publication No. 2008-77272 (published on Apr. 3, 2008)

Patent Document 2: Japanese Patent Application Laid-Open Publication No. 2008-65504 (published on Mar. 21, 2008)

Patent Document 3: Japanese Patent Application Laid-Open Publication No. 2008-226282 (published on Sep. 25, 2008)

Patent Document 4: Japanese Patent Application Laid-Open Publication No. 2007-41790 (published on Feb. 15, 2007)

Patent Document 5: Japanese Patent Application Laid-Open Publication No. 2005-122450 (published on May 12, 2005)

### SUMMARY OF THE INVENTION

### Problems to be Solved by the Invention

However, the technology disclosed in Patent Document 1 requires two touches to perform the input. Furthermore, the touch panel has to be touched for the second time only when the enlarged display appears after the first touch. Such repetitive operations are inefficient.

According to the technology disclosed in Patent Documents 2 to 4, after an enlarged image is shown by a touch, once the finger is lifted from the touch panel, an input is performed. Therefore, an input is performed even if the touch panel is touched momentarily by accident. Also, once the touch panel is touched, the input is confirmed simply by lifting the finger from the panel. Consequently, the finger must be moved while remaining in contact with the touch panel.

In contrast, according to the technology disclosed in Patent Document 5, an input is performed if an input button is touched even very slightly. Therefore, when an operator moves a finger, a touch pen, or the like close to the touch panel, if the tip of the finger or the like touches the touch panel by accident, the input is performed.

The present invention was devised in consideration of the problems described above, and is aiming at providing a highly convenient display device that, when an operator moves a finger or an object close to the touch panel or lightly touches the touch panel, can perform functions different from the functions conducted by a normal touch on the input button.

### Means for Solving the Problems

In order to solve the problems described above, the display device is configured to include: a display panel that displays input buttons on a display screen; a state determining section that determines an input button to be in an inputted state when an operator's finger or an object is in contact with the input button with a contact area that is at least as large as a prescribed area, that determines the input button to be in a semi-inputted state when the operator's finger or the object is in contact with the input button with a contact surface smaller than the prescribed area or when the distance between the operator's finger or the object and the input button in a normal direction is no greater than a prescribed distance and the finger or the object is not in contact with the input button, and that determines the input button to be in a non-inputted state when the operator's finger or the object is away from the input button by a distance greater than the prescribed distance in the normal direction; and an information processing section that performs a function associated with the individual states of the input button according to the state determined by the state determining section.

According to the configuration described above, the input button is determined to be in the semi-inputted state not only when the operator moves a finger or the like close to the input button, but also when the input button is touched lightly.

Therefore, even if the operator is not accustomed to the soft keys, he/she can operate them in the similar manner as he/she would press the hard keys halfway.

Here, a function that is associated with an input button and is performed when the input button is determined to be in the inputted state is referred to as input function, and the performing of this function is referred to as input process. Also, a function that is associated with an input button and is performed when the input button is determined to be in the semi-inputted state is referred to as semi-input function, and the performing of this function is referred to as semi-input process. Here, when a function is referred to as performed, it means that the processing program for performing the function associated with the input button is executed.

According to the disclosures in Patent Documents 2 to 4, the input process is performed when the operator's finger or the like touches the input button, or when the operator's finger or the like is lifted from the input button after touching it. As a result, according to the disclosure in Patent Documents 2 to 4, once a semi-input process is performed, the input process is always performed. However, according to the configuration described above, the semi-input process alone can be performed even after the input button is touched by the operator's finger or the like. Therefore, the technology provides high convenience to users.

Also, according to the configuration described above, by moving a finger or the like close to an input button or touching an input button lightly, the semi-input process can be performed before the input process of the input button is performed. Therefore, a repetitive operation mentioned in Patent Document 1 is not necessary to perform an input process. As a result, the operation performance can be improved.

Also, because the semi-input process can be performed simply by moving a finger or the like close to the input button or by touching the input button lightly, the operator can first verify the outcome of performing the semi-input function associated with the input button about to be inputted, and then press the input button to perform the input function. As a result, a correct input process can be performed, and the semi-input process verification by the operator and then the input process can be conducted in an uninterrupted manner.

Therefore, the configuration described above can provide a highly convenient display device that, when a finger or an object is moved close to the display screen or when a finger or an object touches the display screen lightly, can perform a function that is different from the function performed by a regular touch on the input button.

### Effects of the Invention

As described above, the above-mentioned display device provides a semi-input function through the use of soft keys, which provides a similar effect of pressing the hard keys halfway. In the semi-input function, the state determining section determines that the input button is in an inputted state when an operator's finger or an object is in contact with the input button with a contact area that is at least as large as a prescribed area, determines that the input button is in a semi-inputted state when the operator's finger or the object is in contact with the input button with a contact area that is smaller than the prescribed area or when the distance between the operator's finger or the object and the input button in the normal direction is no greater than a prescribed distance and the finger or the object is not in contact with the input button, and determines that the input button is in a non-inputted state when the operator's finger or the object is away from the input button by a distance greater than the prescribed distance in the normal direction.

Therefore, according to the above-mentioned display device, even if the operator is not accustomed to the soft keys, he/she can operate them in a similar manner as he/she would press the hard keys halfway. Also, the semi-input process alone can be performed even after the input button is touched by the operator's finger or the like. Therefore, the technology provides high convenience to users.

Also, an operation does not have to be repeated to perform the input process. As a result, the operation performance can be improved.

Also, because the semi-input process can be performed simply by moving a finger or the like close to the input button or by touching the input button lightly, the operator can first verify the result of performing the semi-input function associated with the input button about to be inputted, and then press the input button to perform the input function. As a result, a correct input process can be performed, and the semi-input process verification by the operator and then the input process can be performed in an uninterrupted manner.

Therefore, when a finger or an object is moved closed to the display screen or when a finger or an object touches the display screen lightly, the display device described above can perform a function that is different from the function performed by a regular touch on the input button. That is, the display device is unconventional and highly convenient, having the advantages of both the hard key and the soft key.

### BRIEF DESCRIPTION OF THE DRAWINGS

FIG. 1 is a block diagram schematically showing the configuration of a portable phone according to an embodiment.

FIG. 2 is a block diagram schematically showing the configuration of the portable phone according to an embodiment.

FIG. 3(a) and FIG. 3(b) schematically show the exterior appearance of the portable phone according to an embodiment.

FIG. 4 is a plan view schematically showing the main section of a liquid crystal panel used in the portable phone according to an embodiment.

FIG. 5 is a plan view showing the configuration of a pixel of the liquid crystal panel shown in FIG. 4.

FIG. 6 is a plan view schematically showing the arrangement of two types of light sensors, i.e., semi-input sensors and input sensors, which are used as the light sensors shown in FIG. 4.

FIG. 7 is a cross-sectional view schematically showing the main section of the liquid crystal panel where a visible light sensor is used as the light sensor of the panel.

FIG. 8 is a cross-sectional view schematically showing the main section of the liquid crystal panel where an infrared light sensor is used as the light sensor of the panel.

FIG. 9 is another cross-sectional view showing the main section of the liquid crystal panel where an infrared light sensor is used as a sensor of the panel.

FIG. 10(a) to FIG. 10(c) illustrate the relationship between the distance from the display screen of the display section to the fingertip of an operator and the darkness of the shadow formed according to the distance.

FIG. 11 is a graph showing the relationship between the distance from the display screen of the display section to the fingertip of an operator and the light amount received by the light sensor.

FIG. 12 is a flowchart showing the flow of processes of a touch operation by the state determining section and the information processing section.

FIG. 13(a) to FIG. 13(d) show an example of the semi-input process.

FIG. 14 is another plan view schematically showing the arrangement of two types of light sensors, i.e., semi-input sensors and input sensors, which are used as the light sensors shown in FIG. 4.

### DETAILED DESCRIPTION OF EMBODIMENTS

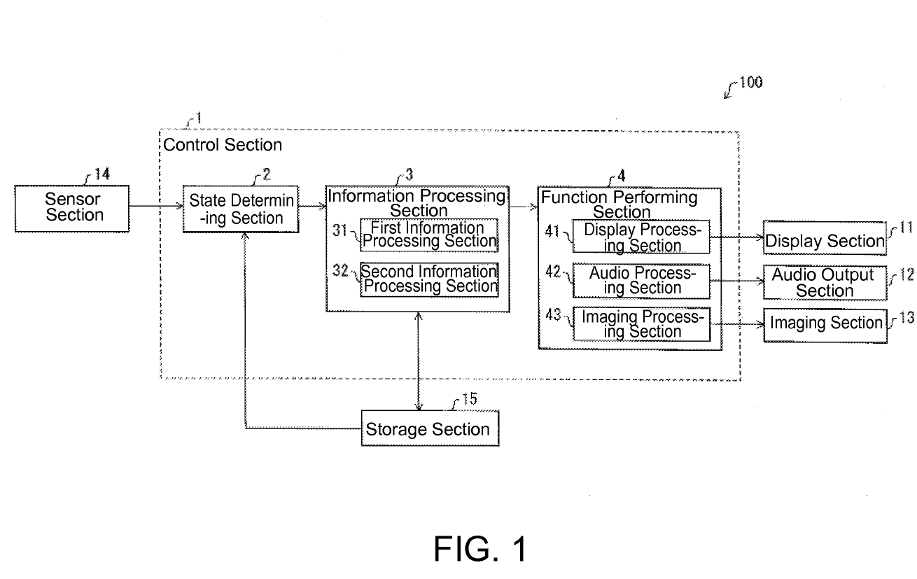

A display device according to an embodiment is described below with reference to FIG. 1 to FIG. 14.

A portable phone is used as an example of the display device of this embodiment.

<Exterior Appearance of the Portable Phone>

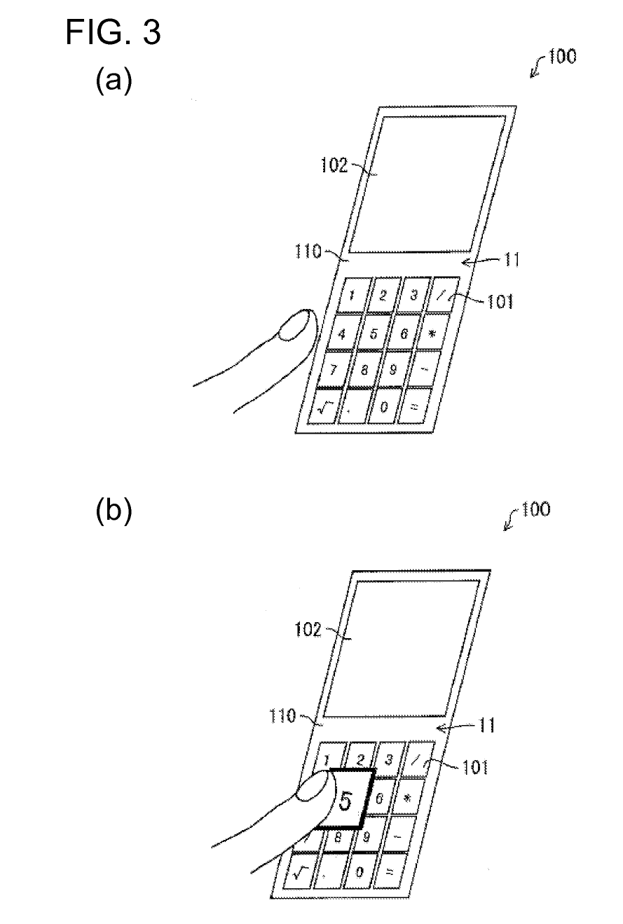

FIG. 3(a) and FIG. 3(b) schematically show the exterior appearance of a portable phone according to this embodiment. FIG. 3(a) shows when an input button is in the non-inputted state, and FIG. 3(b) shows when the input button is in the semi-inputted state. The non-inputted state is a static state, and the semi-inputted state provides a similar effect of pressing the hard key halfway.

The display section 11 of a portable phone 100 shown in FIG. 3(a) and FIG. 3(b) displays ten keys, which are input buttons 101 (function buttons and selection buttons) composed of soft keys. Also, the display section 11 displays an input result display section 102, as well as the input buttons 101, where information associated with the input buttons 101 is displayed. A display screen 110 in the display section 11 is formed into a full flat shape, for example.

The display section 11 is constituted of a display panel such as, for example, a liquid crystal panel. The above-mentioned display panel is a combination of a display panel and a touch panel, and has touch-panel functions. The display screen 110 is used as a touch panel (operation input section). Therefore, the display section 11 is used as both a display section and an operation input section.

The portable phone 100 has semi-input functions, which provide a similar effect of pressing hard keys halfway. When an operator of the portable phone 100 touches an input button 101 displayed in the display section 11 with a finger, a touch pen, or the like, the input of the input button 101 is performed, and the function associated with the input button 101 is performed. On the other hand, when the operator moves a finger, a touch pen, or the like close to the input button 101 or touches the input button 101 slightly enough not to cause the input to be performed, a function (semi-input function), which is associated with the input button 101, but is not the inputting function, is performed.

A configuration for performing the semi-input function is described in detail below.

In the description below, in order to facilitate the understanding of the technology, an example where an operator touches the display screen 110 with a finger to perform the input of an input button is discussed.

<Schematic Description of the Configuration of Portable Phone>

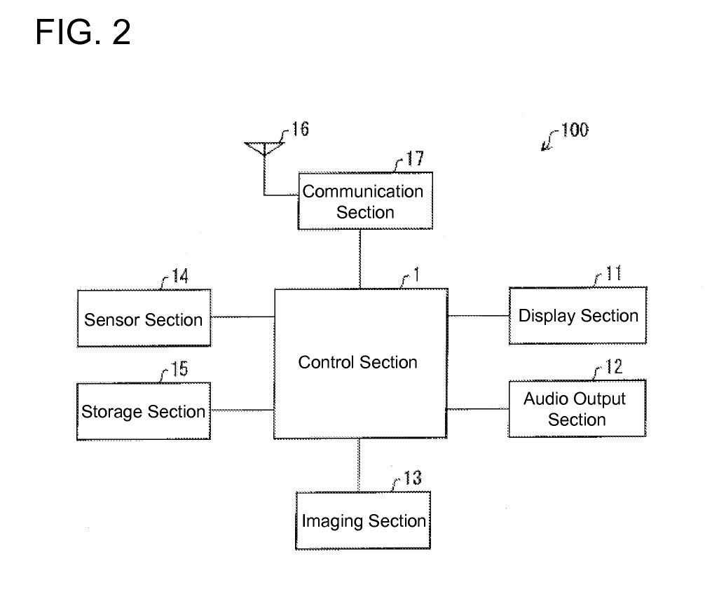

FIG. 2 is a block diagram schematically showing the configuration of a portable phone according to this embodiment.

As shown in FIG. 2, the portable phone 100 according to this embodiment includes a control section 1, a display section 11, an audio output section 12, an imaging section 13, a sensor section 14, a storage section 15, an antenna section 16, a communication section 17, an audio input section (not shown), and the like.

The control section 1 controls various configurations within the portable phone 100 in a comprehensive manner. The function of the control section 1 can be performed, for example, when the program stored in the storage section 15 is executed by CPU (Central Processing Unit).

The display section 11 displays contents such as images, texts, and motion pictures based on the display signal from the control section 1. As described above, a display panel such as a liquid crystal display panel is used for the display section 11.

This embodiment is described below, citing an example in which a liquid crystal panel is used as the display panel. Among a variety of display panels, liquid crystal panels, where liquid crystals are used as the display medium, have advantages over others, because they feature a thin profile, light weight, small power consumption, and the like. Liquid crystal panels, therefore, are especially suitable for the display section of small mobile terminals such as portable phones.

In this embodiment, the display mode of the liquid crystal panel is not particularly limited. Any display mode such as TN (Twisted Nematic) mode, IPS (In Plane Switching) mode, or VA (Vertical Alignment) mode may be used.

On the back side of the liquid crystal panel, a backlight (not shown) is provided as necessary.

The audio output section 12 converts the audio signal sent from the control section 1 into an acoustic wave and outputs it outside. The audio output section 12 includes a speaker, an earphone, a connector for audio output, and the like, for example.

The imaging section 13 captures images using a camera or the like based on the control signal from the control section 1, and generates data such as images and motion pictures. The imaging section 13 also sends the generated data to the control section 1. Picture data and the like captured by the imaging section 13 is stored, for example, in the storage section 15.

For the imaging section 13, an imaging element such as CCD (Charge Coupled Device), CMOS (Complementary Metal-oxide Semiconductor), or the like, for example, is used.

The sensor section 14 provides the liquid crystal panel with the touch panel function. In the sensor section 14, a plurality of light sensors corresponding to individual pixels in the display section 11 are disposed.

The storage section 15 is constituted of a memory that stores various data and programs. In the storage section 15, processing programs for performing functions associated with the inputted state and the semi-inputted state of the input buttons 101 are stored.

In the storage section 15, display regions of the individual input buttons 101 are defined by X and Y coordinates on the display screen 110.

Specifically, the storage section 15 includes a coordinates storage section, an application information storage section, and the like.

The storage section 15 may be constituted of ROM (Read Only Memory), RAM (Random Access Memory), or flash ROM. The processing program may be rewritable through the communication section 17, for example.

ROM stores programs that are necessary when, for example, the control section 1 operates, and also stores fixed data such as the control data. RAM temporarily stores data related to communication, data used for calculation, and calculation results, for example. The storage section 15 also includes a flash memory that stores, for example, picture data captured by the imaging section 13, and non-volatile, rewritable memory such as EEPROM.

The antenna section 16 sends radio waves to outside and receives radio waves from outside.

The communication section 17 conducts data communication with outside through the antenna section 16. The data communication may be a wired communication or a wireless communication. In the communication section 17, various processes such as the base band signal process, data modulation and demodulation processes, and RF (Radio Frequency) process are conducted.

<Schematic Description of the Configuration of Control Section 1>

Next, the configuration of a control section 1 is schematically described with reference to FIG. 1.

FIG. 1 is a block diagram schematically showing the configuration of a portable phone 100 according to this embodiment.

As shown in FIG. 1, the control section 1 includes a state determining section 2, an information processing section 3, and a function performing section 4.

The state determining section 2 detects (calculates) the coordinates of the operator's finger or an object on the display screen 110 based on the output from the sensor section 14, and from the detected coordinates, detects an input button 101 the operator is about to touch. Then, the detected input button 101 is determined to be in the (1) inputted state, (2) semi-inputted state, or (3) non-inputted state.

The information processing section 3 runs the processing program for performing functions associated with the individual states determined by the state determining section 2.

The information processing section 3 includes a first information processing section 31 and a second information processing section 32.

The first information processing section 31 reads from the storage section 15 a processing program for performing the function (input process) associated with the inputted state, and runs the processing program. Then, the execution result of the processing program is outputted to the function performing section 4 as the process result.

The second information processing section 32 reads from the storage section 15 a processing program for performing the function associated with the semi-inputted state, and runs the processing program. Then, the execution result of the processing program is outputted to the function performing section 4 as the processing result.

Here, the function associated with the semi-inputted state (i.e., the semi-input process performed during the semi-inputted state) is not particularly limited. It only needs to be different from the function associated with the inputted state. The semi-input process is described in detail below.

Upon receipt of the execution result of the processing program run by the information processing section 3 as the processing result from the information processing section 3, the function performing section 4 outputs a control signal according to the processing result sent from the information processing section 3. This way, the function performing section 4 controls the performing of functions in sections connected to the control section 1.

The function performing section 4 includes, for example, a display processing section 41, an audio processing section 42, an imaging processing section 43, a communication processing section (not shown), and the like.

The display processing section 41 outputs a control signal for displaying images to the display section 11 according to the processing result of the first information processing section 31 or the second information processing section 32.

That is, to the display processing section 41, the execution result of the processing program run by the first information processing section 31 or the second information processing section 32 is inputted as the processing result from the information processing section 3.

Upon receipt of the processing result, the display processing section 41 outputs to the display section 11 a control signal, which is the image signal for displaying images according to the processing result of the first information processing section 31 or the second information processing section 32.

The audio processing section 42 outputs to an audio output section 12 a control signal, which is an audio signal for outputting sound according to the processing result of the first information processing section 31 or the second information processing section 32.

To the audio processing section 42, audio signals from an audio input section is also inputted. The audio input section includes a microphone and the like, and converts the radio wave inputted from outside into an audio signal, which is an electrical signal, and sends it to the audio processing section 42. The audio processing section 42 includes an A/D converter, a D/A converter, an amplifier, and the like. The audio signal inputted from the audio input section is sent to the audio output section 12, the communication section 17, and the like through the audio processing section 42.

The imaging processing section 43 outputs to the imaging section 13 a control signal for capturing images according to the processing result of the first information processing section 31 or the second information processing section 32.

The function performing section 4 may output to the communication section 17 a control signal for communication according to the processing result sent from the information processing section 3 through a communication processing section (not shown). That is, the communication processing section may output to outside, for example, a signal for performing functions according to the processing result sent from the first information processing section 31, through the communication section 17.

<Schematic Description of the Configuration of Liquid Crystal Display Panel>

Next, the configuration of the liquid crystal panel is schematically described.

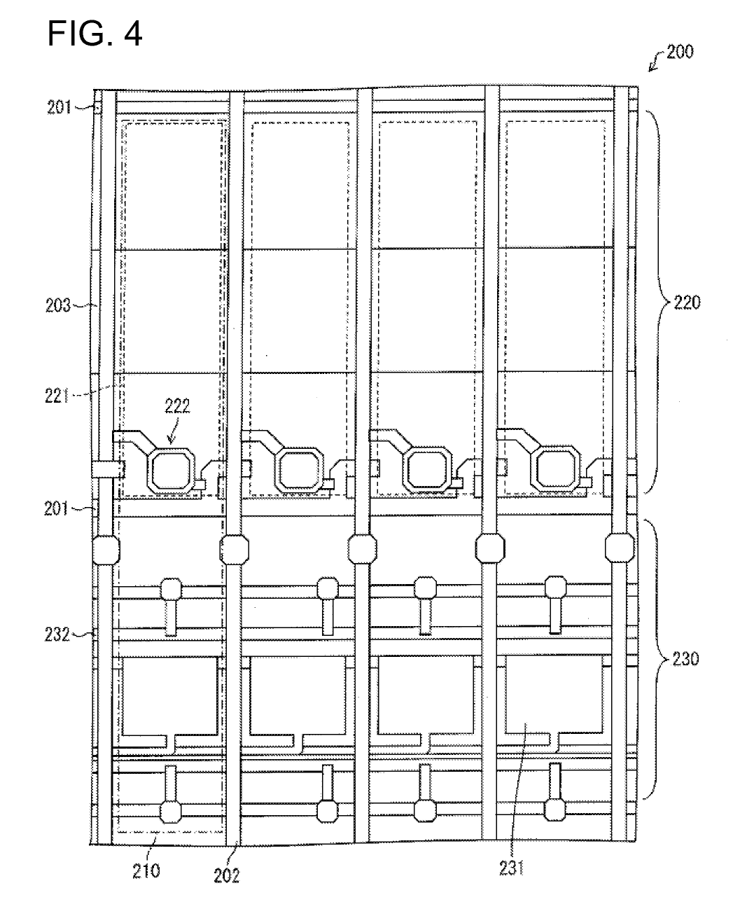

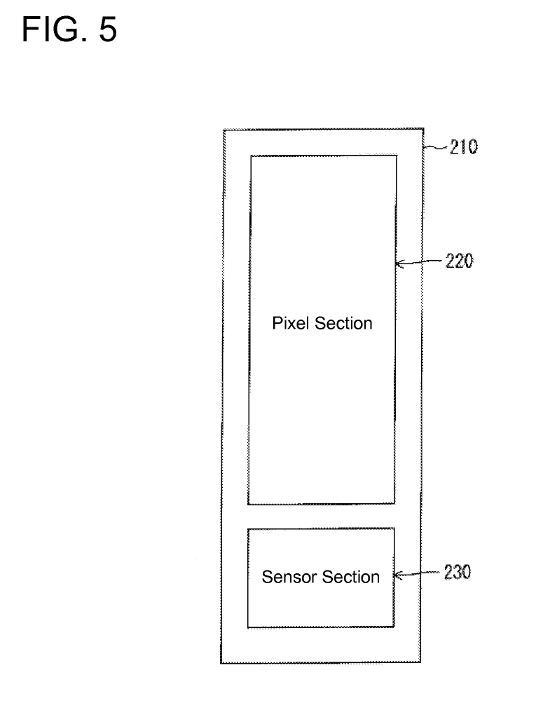

FIG. 4 is a plan view schematically showing the configuration of the main section of the liquid crystal panel used for the portable phone 100. FIG. 5 is a plan view showing the configuration of a pixel of the liquid crystal panel shown in FIG. 4.

The liquid crystal panel 200 shown in FIG. 4 is an active matrix type liquid crystal panel configured to have a plurality of pixels 210 arranged in a matrix. As shown in FIG. 4 and FIG. 5, in each pixel 210, a pixel section 220 constituted of a pixel electrode 221 made of a transparent electrode material such as ITO (Indium Tin Oxide) and a sensor section 230 in which a light sensor 231 is formed are disposed. The sensor section 230 is disposed adjacent to the pixel section 220.

As shown in FIG. 4, in each of the pixel sections 220, a TFT (Thin Film Transistor) 222 is disposed as the switching element.

The liquid crystal panel 200 includes gate wirings 201, source wirings 202, and auxiliary capacitance wirings 203 as wirings for display. The gate wirings 201 and source wirings 202 are arranged to intersect with each other. Each of the auxiliary capacitance wirings 203 is disposed between adjacent gate wirings 201, and in parallel to the gate wirings 201.

The pixel electrodes 221 are each disposed in a region defined by the gate wirings 201 and the source wirings 202. At each of the intersections of the gate wirings 201 and the source wirings 202, a TFT 222 is disposed. The TFTs 222 are connected to the respective gate wirings 201, source wirings 202, and pixel electrodes 221.

The liquid crystal panel 200 has sensing wirings 232, which are a plurality of wirings connected to the light sensor 231. These include a reset wiring and an output wiring of the light sensor 231.

The configuration shown in FIG. 4 and FIG. 5 is the same as that of conventional liquid crystal panels having a so-called in-cell photo sensor configuration, which includes photo sensors inside the liquid crystal panel (in-cell photo sensor panel). Detailed description of the configuration, therefore, is omitted.

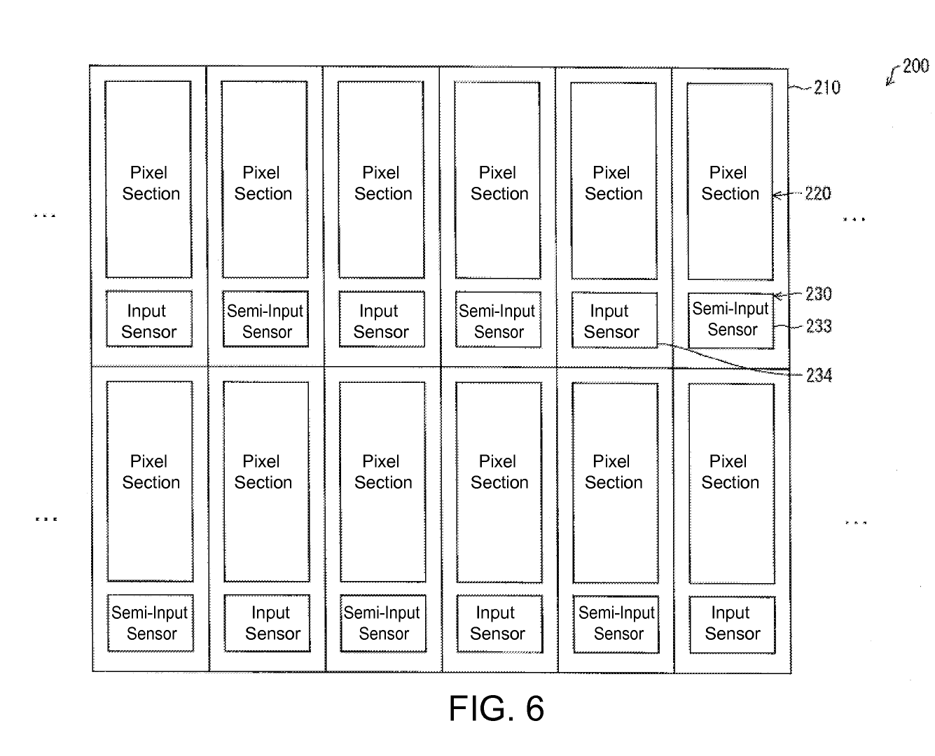

FIG. 6 is a plan view schematically showing the arrangement of the light sensors 231 shown in FIG. 4, where two types of light sensors 231, i.e., semi-input sensors and input sensors, are used.

The liquid crystal panel 200 shown in FIG. 6 includes in each pixel a light sensor 231, which is either a light sensor for semi-input recognition (hereinafter referred to as “semi-input sensor”) 233 or a light sensor for input recognition (hereinafter referred to as “input sensor”) 234.

In the description below, when the semi-input sensor 233 and the input sensor 234 are not distinguished from one another, the semi-input sensor 233 and the input sensor 234 are collectively called “light sensors 231.”

The semi-input sensors 233 and the input sensors 234 are both disposed in the display region of the liquid crystal panel 200 with an appropriate ratio between the them. FIG. 6 shows an example in which pixels 210 with a semi-input sensor 233 and pixels 210 with an input sensor 234 are arranged adjacent to each other so that the semi-input sensor 233 and the input sensor 234 are arranged alternately, forming a checker pattern.

As shown in FIG. 6, if either a semi-input sensor 233 or an input sensor 234 is provided as the light sensor 231 in each pixel 210, the transmittance that can be obtained is similar to that of the conventional in-cell photo sensor panels. Also, the liquid crystal panel 200 can be manufactured without increasing the number of manufacturing processes of the conventional in-cell photo sensor panels. The liquid crystal panel 200, therefore, can be manufactured without increasing the takt time or the cost.

For the semi-input sensor 233 and the input sensor 234, light sensors having the same structure can be used. Also, as the semi-input sensor 233 that is exclusively for the semi-input recognition, a light sensor having the same film structure as the input sensor 234 but having different pixel parameters such as the shape and the thickness of each film may be used.

The difference between the semi-input sensor 233 and the input sensor 234 is that they have different thresholds for turning ON the sensing. The ON status of each light sensor 231 may be determined by the calculation using the photo current of each light sensor 231, or by detecting an ON signal outputted from the light sensor 231.

<Schematic Description of the Configuration of the Light Sensor>

Here, the configurations of the light sensor used as the semi-input sensor 233 and the light sensor used as the input sensor 234, together with the cross-sectional configuration of the liquid crystal panel 200, are schematically described.

In the description below, it is assumed that the operator is at the surface side (top side), and the opposite side is the back side (bottom side).

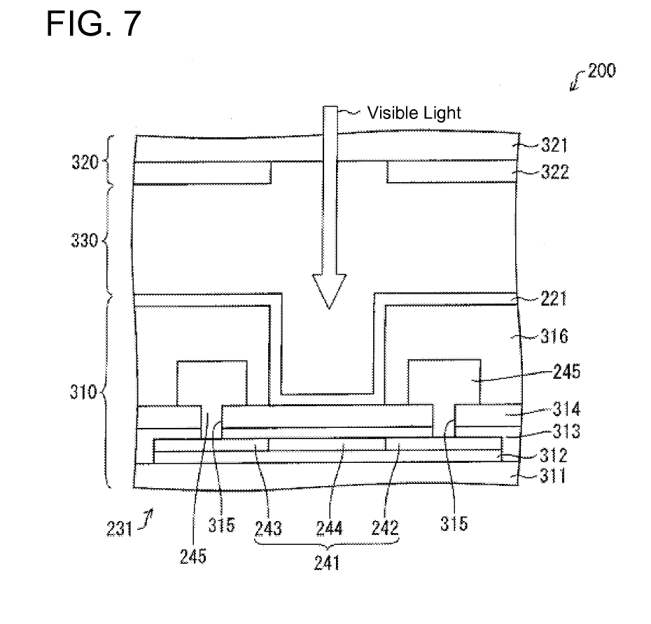

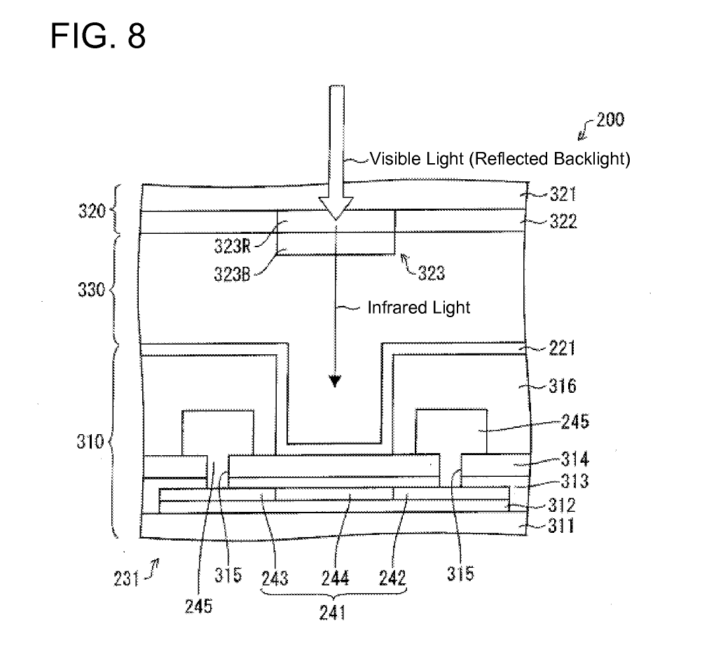

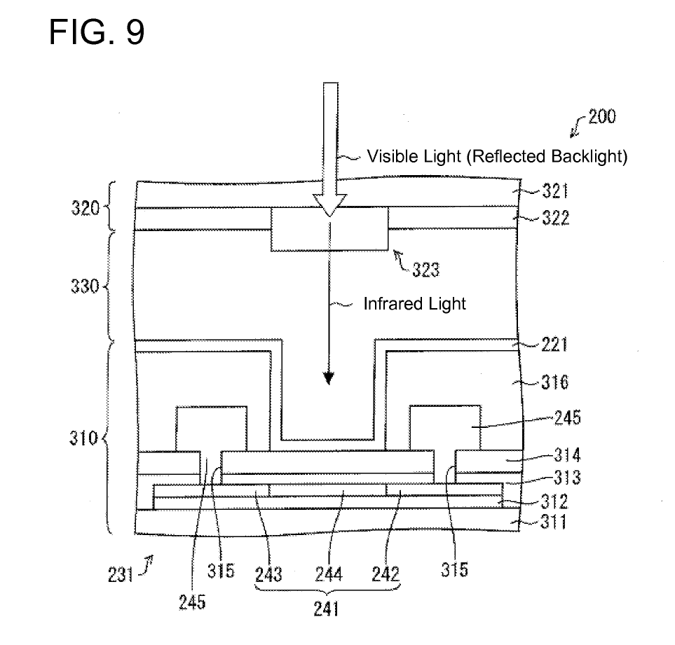

FIG. 7 is a cross-sectional view schematically showing the configuration of the main section of the liquid crystal panel 200, where a visible light sensor is used as the light sensor 231. FIG. 8 and FIG. 9 are cross-sectional views schematically showing the configuration of the main section of the liquid crystal panel 200, where an infrared light sensor is used as the light sensor 231.

As shown in FIG. 7, the liquid crystal panel 200 is configured such that a liquid crystal layer 330 is sandwiched, as the display medium layer, between an active matrix substrate 310 and an opposite substrate 320.

The active matrix substrate 310 is configured such that a light sensor 231, a pixel electrode 221, a switching element which is not shown (TFT 222 in FIG. 4), and the like are disposed on an insulating substrate 311 such as a glass substrate.

As necessary, the active matrix substrate 310 and the opposite substrate 320 are each provided with a polarizing plate (not shown; a front polarizing plate or a back polarizing plate) disposed thereon on the side that is not facing the other substrate. Also, as necessary, a retardation plate (not shown) may be provided at least either between the front polarizing plate and the active matrix substrate 310, or between the back polarizing plate and the opposite substrate 320.

If the front polarizing plate is disposed on the front side of the liquid crystal panel 200, the front polarizing plate may be used as the touch panel. However, the configuration is not limited to this, and another light guide plate may be provided on the front polarizing plate.

For example, a protection plate (not shown) may be provided on the front side of the liquid crystal panel 200, and the surface of the protection plate may be used as the touch surface of the touch panel. The protection plate is made of transparent resin or glass, for example.

The liquid crystal panel 200, as described above, includes a light sensor 231 for each pixel as an in-cell photo sensor. The liquid crystal panel 200 detects the coordinates of the location of the operator's finger on the display screen 110 (see FIG. 5) by detecting the intensity of the light received (received light amount) by the light sensor 231.

In FIG. 7, a case where a photodiode constituted of a thin film diode having a semiconductor layer of PIN structure is used as the light sensor 231 is described as an example. However, this embodiment is not limited to such. A variety of conventional light sensors may also be used.

In the description below, a case where TFT 222 is a top gate type TFT is used as an example. However, this embodiment is not limited to such. A bottom gate type TFT may also be used.

As shown in FIG. 7, a light-shielding layer 312 is disposed on a part of the insulating substrate 311. Also, over the insulating substrate 311, a base insulating film (not shown) is provided as necessary to cover the light-shielding layer 312.

The semiconductor layer 241 of the light sensor 231 is disposed over the insulating substrate 311 via the light-shielding layer 312 and the base insulating film (not shown). The light-shielding layer 312 and the semiconductor layer 241 are formed in an island shape.

The semiconductor layer 241 has a PIN structure, in which a p layer 242 (p type semiconductor layer) and an n layer 243 (n type semiconductor layer) sandwich an i layer 244 (a semiconductor layer or an intrinsic semiconductor layer having a lower impurity concentration than the p type semiconductor or the n type semiconductor).

Because the semiconductor layer 241 has the PIN structure as described above, the light sensitivity of the light sensor 231 can be improved. Therefore, the sensing accuracy of the light sensor 231 can further be improved.

The light sensor 231 generates the current (photo current) representing the intensity of the light (light amount) that entered the i layer 244. That is, in the light sensor 231, the i layer 244 functions as the light-receiving region.

Therefore, the light-shielding layer 312 is preferably formed on the back side of the light sensor 231 to cover at least the i layer 244. This way, the light emitted from the backlight is prevented from being detected by the light sensor 231.

The semiconductor layer 241 of the light sensor 231 is formed in the same layer as the semiconductor layer (not shown) of TFT 222. That is, TFT 222 is disposed over the insulating substrate 311 through the base insulating film, covering a region where the light-shielding layer 312 is not present.

The semiconductor layer 241 of the light sensor 231 and the semiconductor layer of TFT 222 are covered with the same gate insulating film 313.

Over the gate insulating film 313, gate electrodes (not shown), gate wirings 201 (see FIG. 4), auxiliary capacitance wirings 203 (see FIG. 4), and the like are formed.

The semiconductor layer 241, the gate electrode, and the like are covered with a first interlayer insulating film 314 formed on the gate insulating film 313. For the first interlayer insulating film 314, an inorganic insulating film such as a silicon oxide film or a silicon nitride film is used.

The p layer 242 and the n layer 243 are connected to the electrodes 245 through contact holes 315 provided in the first interlayer insulating film 314.

On the other hand, the source region and the drain region of TFT 222 are connected to the source electrode (not shown) and the drain electrode (not shown) through contact holes (not shown) provided in the first interlayer insulating film 314.

The source electrode and the drain electrode are covered with a second interlayer insulating film 316 formed over the first interlayer insulating film 314. For the second interlayer insulating film 316, an organic insulating film such as acrylic resin is used. On the second interlayer insulating film 316, the pixel electrodes 221 are patterned as shown in FIG. 4.

On the other hand, the opposite substrate 320 is configured to include an insulating substrate 321 such as a glass substrate with a light-shielding film 322, a color filter for display (not shown), a black matrix, an opposite electrode, and the like formed thereon on the side facing the active matrix substrate 310.

The light-shielding film 322 is formed of the same material as the black matrix (not shown) provided in the pixel section 220 and also formed simultaneously with the black matrix. The light-shielding film 322 is formed into a shape according to the positions of the pixel electrode 221 and the light sensor 231, and the pattern shapes of wirings.

Here, as shown in FIG. 7, because the light-shielding film 322 is disposed in regions other than the i layer 244, which will be the light-receiving region, visible light can be prevented from entering all regions except for the i layer 244.

If the light sensor 231 is a visible light sensor, the light sensor 231 is formed as a light-receiving element having a sensitivity to visible light. If the light sensor 231 is a visible light sensor, the light sensor 231 senses all visible light. Such a light sensor 231 has a poor sensing capability in an environment with low ambient light such as an indoor environment.

On the other hand, if an infrared light sensor is used as the light sensor 231 as shown in FIG. 8 and FIG. 9, the light sensor 231 is formed as a light-receiving element having a sensitivity to infrared light.

The infrared light sensor 231 senses the reflection of the infrared light included in the backlight light. Therefore, an infrared light sensor 231 can be suitably used in an environment with low ambient light.

If an infrared light sensor is used as the light sensor 231, as shown in FIG. 8 and FIG. 9, a light-shielding body 323 that blocks (reflects) light of a specific frequency component is formed at least at a location facing the i layer 244 of the light sensor 231.

The light-shielding body 323 may be disposed over the light sensor 231 of the active matrix substrate 310, but may alternatively be disposed on the opposite substrate 320 as shown in FIG. 8 and FIG. 9.

FIG. 8 shows an example where an optical filter with a laminated structure of a red (R) color filter 324R and a blue (B) color filter 324B is used as the light-shielding body 323. This way, visible light component (visible wavelengths) of the light entering the light sensor 231 can be blocked. The light sensor 231 conducts the photoelectric conversion of the infrared light that passed through the light-shielding body 323.

According to the configuration described above, the entry of external light (visible light) into the light sensor 231 can be suppressed. As a result, a stable sensing operation can be performed over a wide range of environment without being influenced by the environment outside the device (external light intensity, for example).

FIG. 8 illustrates a case where the light-shielding body 323 is composed of RB color filters 324R and 324B as described above. However, this embodiment is not limited to such.

The light-shielding body 323 only needs to block the visible light component, and may have a laminated structure of an R color filter 324R and a green (G) color filter (not shown), or may alternatively have a laminated structure of a B color filter 324B and a G color filter (not shown). Also, the light-shielding body 323 may have an RGB three-layer structure, instead of the two-layer structure. The light-shielding body 323 with a three-layer structure composed of RGB color filters can suppress the average transmittance of the visible light to below 1%.

Also, the light-shielding body 323 is not limited to an optical filter composed of the laminated color filters described above. The light-shielding body 323 may, as shown in FIG. 9, be an IR resist that transmits the infrared light only. Generally, a thermo resist is known as an IR resist. A resist of a fourth color (i.e., a color that is not R, G, or B) that blocks visible light and transmits infrared light only is used as such a resist.

If the light-shielding body 323 is an optical filter which is made by laminating a plurality of color filters as described above, the light-shielding body 323 can be formed of the same material as and simultaneously with the color filter for display of the pixel section 220. As a result, the manufacturing cost can be reduced compared to the case where the light-shielding body 323 is made of a different material or made in a separate process.

On the other hand, if the light-shielding body 323 is made of an IR resist as described above, zigzag irregularity can completely be prevented.

In the description above, a case where a visible light sensor having a sensitivity to visible light or infrared light, or an infrared light sensor is used as the light sensor 231 is discussed as an example. However, this embodiment is not limited to such. For example, if the backlight emits ultraviolet light, the light sensor 231 can be designed to have a sensitivity to ultraviolet light.

As described above, a conventional light sensor and an in-cell photo panel may be used as the light sensor 231 and as the liquid crystal panel 200, respectively. Therefore, materials and film thicknesses of individual layers can be set in the same manner as in the conventional technologies. Therefore, in this embodiment, descriptions regarding the manufacturing method for the liquid crystal panel 200 and the light sensor 231 and descriptions regarding the materials and the film thickness of the layers are omitted.

<Determination of the State of the Input Button>

The state determining section 2 determines that an input button is in the inputted state when the operator's finger or an object is touching the display screen 110 with a contact area that is at least as large as a prescribed area. When the operator's finger or the object is touching the display screen 110 with a contact area that is smaller than the prescribed area, or the distance between the operator's finger or the object and the display screen 110 in the normal direction (Z axis direction) is not greater than a prescribed distance and the operator's finger or the object is not in contact with the display screen 110, the state determining section 2 determines that the input button is in the semi-inputted state. The state determining section 2 also determines that an input button is in the non-inputted state when the operator's finger or the object is away from the display screen 110 by a distance that is more than the prescribed distance in the normal direction.

Here, when it is said that an operator's finger or an object is touching the display screen 110 with a contact area that is at least as large as the prescribed area or smaller than the prescribed area, it means that the finger or the object is in contact with the display region of an input button 101 displayed on the display screen 110 (i.e., a region associated with the input button 101, such as the display region of the input button 101) with a contact area at least as large as the prescribed area or smaller than the prescribed area. Also, the normal direction refers to a direction perpendicular to the display screen 110 (i.e., the direction perpendicular to the surface of the liquid crystal panel 200).

The method for determining the input button state by the state determining section 2 is described in detail below.

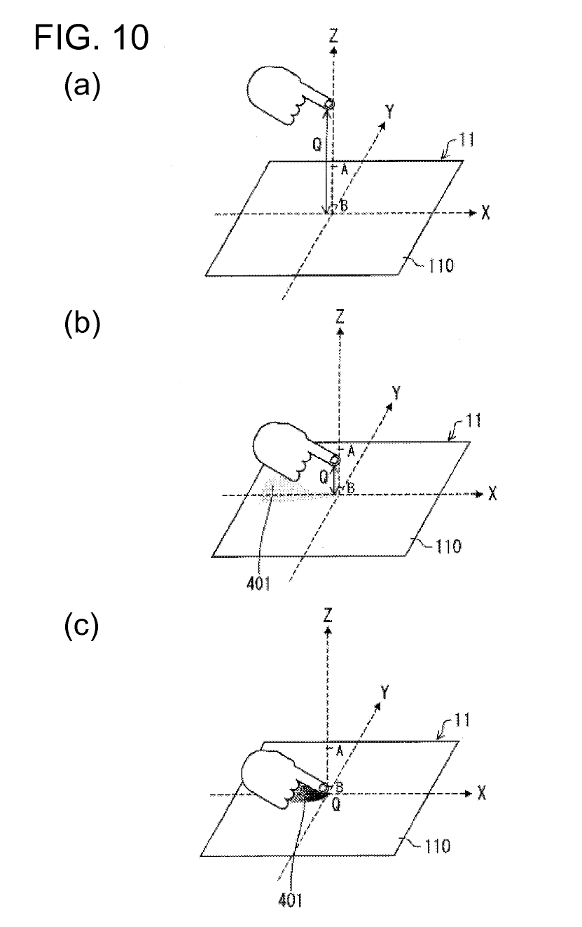

FIG. 10(a) to FIG. 10(c) show the relationship between the distance from the display screen 110 of the display section 11 to the operator's fingertip and the darkness of the shadow formed according to the distance.

As shown in FIG. 10(a) to FIG. 10(c), when the distance from the display screen 110 of the display section 11 to the operator's fingertip is Q, the shorter the distance Q becomes, the darker the shadow 401 formed on the display screen 110 by the operator's fingertip becomes.

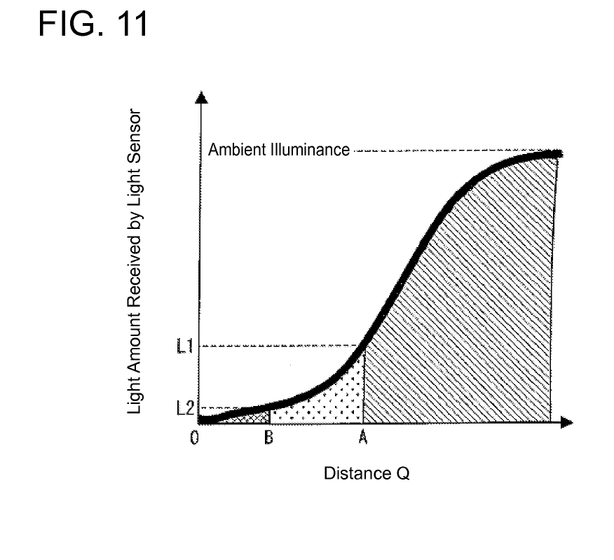

FIG. 11 is a graph showing the relationship between distance Q and the light amount entering the light sensor 231 (received light amount).

As shown in FIG. 11, the shorter the distance Q becomes, due to the shadow 401 formed by the operator's finger or hand, the light amount that enter the light sensor 231 is reduced.

Therefore, by configuring the semi-input sensor 233 and the input sensor 234 each having its own turning ON threshold such that they turn ON depending on the light amount the respective sensors receive, the input button 101 that the operator is about to touch can be detected, and the distance between the input button 101 and the operator's fingertip (i.e., the distance Q from the display screen 110 at the display region of the input button 101 and the operator's fingertip) can be determined.

Also, the contact area between the operator's finger pad and the display screen 110 differs when the operator touches the display screen 110 lightly with his/her fingertip and when the operator touches the display screen 110 firmly.

Consequently, by configuring the plurality of semi-input sensors 233 and input sensors 234 each having its own turning ON thresholds such that they turn ON depending on the light amount the respective sensors receive, the difference in the contact area can be identified from the number of the semi-input sensors 233 that are ON and the number of the input sensors 234 that are ON.

As shown in FIG. 10(b) and FIG. 11, when the distance from the display screen 110 that initiates the semi-input process is A (0<A), if the distance Q from the display screen 110 of the display section 11 to the operator's fingertip is equal to A or smaller (A≧Q), the light amount entering the semi-input sensors 233 and the input sensors 234 in the region that satisfies the relation A≧Q is L1 or less, as shown in FIG. 11.

Also, when the distance from the display screen 110 to a portion of the operator's fingertip that is nearly touching the display screen 110, for example, is B (0<B<<A), if the distance Q from the display screen 110 of the display section 11 to the operator's fingertip is equal to B or smaller (B≧Q), the light amount entering the semi-input sensors 233 and the input sensors 234 in the region that satisfies the relation B≧Q is L2 (L2<L1) or less as shown in FIG. 11.

Here, when the threshold for the semi-input sensor 233 turning ON is L1 (first threshold), and the threshold for the input sensor 234 turning ON is L2 (second threshold), the state of the input button 101 can be determined by detecting (extracting) the light sensors 231 that are ON using the photo current or the ON signal outputted from individual light sensors 231.

The slope of the curve shown in FIG. 11, i.e., the threshold, can be modified by adjusting the light amount entering each of the light sensors 231 by changing pixel parameters such as the shapes and thicknesses of films constituting the semi-input sensors 233 and the input sensors 234.

The pixel parameters include, for example, the semiconductor pattern shape of the light sensor 231 (Si shape); the shape of black matrices for light shielding such as the light-shielding film 322 and the light-shielding body 323, color filters, and resist patterns for light shielding; the shape, thickness, and the like of the interlayer insulating film (especially the second interlayer insulating film 316). The light-receiving area of the light sensor 231 can be changed by modifying these pixel parameters.

When TFT is used in the light sensor 231, the pixel parameters include TFT channel length (L length), channel width (W length), the length of a Lov region in the direction of the channel length (Lov length), the length of a Loff region in the direction of the channel length (Loff length); the dose amount of individual doping layers; TFT parameters such as the number of the gate channels and the like.

The Loff region refers to a region of LDD (lightly doped drain) region that does not overlap the gate electrode through the gate insulating film. The Lov region refers to a region of LDD region that overlaps the gate electrode through the gate insulating film.

As more light enters the light sensor 231, the sensitivity increases, but so does noise. It is desirable to adjust the balance between them.

The slope of the above-mentioned curve, i.e., the pixel parameter, is preferably adjusted such that the sensing of the semi-input sensor 233 turns ON by, for example, the darkness of the shadow of a hand, and that the sensing of the input sensor 234 finally turns ON by, for example, the darkness of the shadow formed when a finger touches the display screen 110.

<Touch Operation Process>

Next, the flow of the touch operation process performed by the state determining section 2 and the information processing section 3 is described.

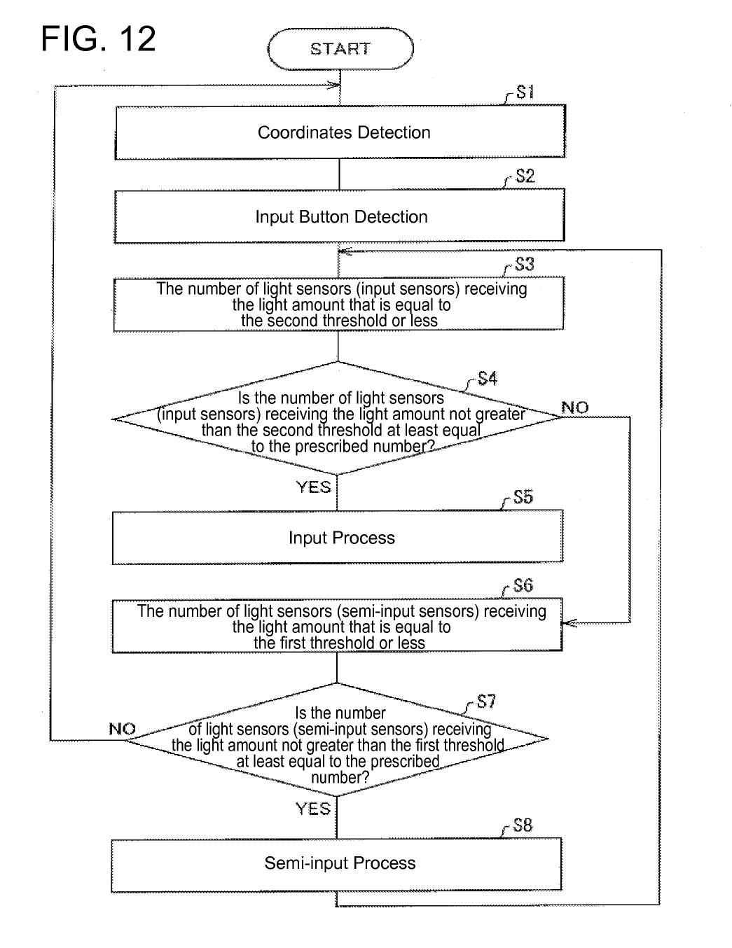

FIG. 12 is a flowchart showing the flow of the touch operation process performed by the state determining section 2 and the information processing section 3.

In the display section 11, the state determining section 2 first extracts light sensors 231 receiving a light amount of L1 (first threshold) or less to sense a region where the illuminance is lower than the ambient illuminance due to the shadow 401 of a finger or a hand, and determines (calculates) the coordinates of the finger or the like on the display screen 110 in the sensed region (Step S1).

Here, extraction of light sensors 231 receiving the light amount of L1 (first threshold) or less is conducted by extracting the light sensors 231 that are ON (i.e., semi-input sensors 233 that are ON).

In the storage section 15, display regions of individual input buttons 101 are defined with X and Y coordinates on the display screen 110.

For example, in the storage section 15, coordinates representing the display regions of individual input buttons 101 are stored. The input button 101 corresponding to the coordinates detected is determined to be the input button 101 that is about to be touched.

The coordinates stored in the storage section 15 only need to be able to identify the display regions of the individual input buttons 101. There is no need for the storage section 15 to store all coordinates. For example, stored coordinates may be those indicating the outer frames (line frames) of the individual input buttons 101, or coordinates of the upper left and lower right of each of the line frames.

The state determining section 2 detects an input button 101 that includes the coordinates detected (i.e., the input button 101 corresponding to the region with an illuminance that is lower than the ambient illuminance) based on the coordinates data or the like stored in the storage section 15 (Step S2).

Next, in the display region corresponding to the detected semi-input sensors 233 (i.e., in the display region of the detected input button 101), the state determining section 2 extracts the number of the light sensors 231 (input sensors 234) receiving the light amount of L2 (second threshold) or less (Step S3).

Next, the state determining section 2 determines whether the number of the light sensors 231 (input sensor 234) extracted in Step S3 is at least the prescribed number (for example, N or more; 0<N) (Step S4). Here, if the number is determined to be N or more, the information processing section 3 performs the input process for the input button 101 (Step S5).

On the other hand, if the number is determined to be under N in Step S4, in the display region of the input button 101 detected in Step S2, the number of the semi-input sensors 233 receiving the light amount of L1 (first threshold) or less is extracted (Step S6).

Next, whether the number of the semi-input sensors 233 extracted in Step S6 is at least the prescribed number (for example, M; 0<M) is determined (Step S7). Here, if the number is determined to be at least M, the semi-input process for the input button 101 is performed (Step S8).

On the other hand, if the number is determined to be M or less in Step S7, the process returns to Step S1.

Thus, in the display region of an input button 101, when the number of the semi-input sensors 233 that are ON is F, and the number of the input sensors 234 that are ON is J, if M≦F and J<N, the semi-input process is performed, and if N≦J, the input process is performed. That is, the input process is performed as long as N≦J is satisfied, regardless of the number of the semi-input sensors 233.

The N and M values may be set as appropriate according to the size of the input button 101, the type of the coordinates detection object on the display screen 110 (i.e., an item used to touch the input button 101, such as the operator's finger, a touch pen, and the like), semi-input and input functions associated with the individual input buttons 101, and the like.

Also, when the operator moves his/her finger away from the display screen 110 or slides the finger to a different location on the display screen after verifying the input button 101 whose semi-input process is being performed, the input button returns to the non-inputted state or the semi-input process of another input button is performed. While the operator is verifying the input button 101 whose semi-input process is being performed, the semi-input process of the input button 101 being verified is repeatedly performed. As a result, the semi-input process condition is maintained (continues).

As described above, due to the operation of the state determining section 2, first, based on the numbers and coordinates of the semi-input sensors 233 and the input sensors 234 that turned ON for sensing when the operator moved his/her finger or the like close to the display screen 110 or touches the display screen 110, a region where the illuminance becomes lower compared to the ambient illuminance (the region where the semi-input sensors 233 turn ON) is sensed. Then, in the sensed region, coordinates of the fingertip or the like are calculated by a program.

From the calculated coordinates, an input button 101 about to be touched is detected. Once the input button 101 is determined to be in the semi-inputted state, a semi-input function (semi-input process) associated with the input button 101, such as enlargement of the input button 101, is performed.

On the other hand, any region where the illuminance is even lower compared to the ambient illuminance due to the shadow formed by a fingertip or the like (the region where the number of the input sensors 234 that turn ON is at least equal to the prescribed number) is sensed. If the input button 101 the operator is about to touch is determined to be in the inputted state, the display region of the inputted button is recognized as a signal input region.

According to this embodiment, as described above, the inputted state, the semi-inputted state, and the non-inputted state are recognized depending on the light amount entering the light sensors 231 and the contact area between an operator's finger or the like and the display screen 110 when the operator's finger or the like is moved close to or touches the display screen 110.

Therefore, according to this embodiment, the semi-input function can be performed not only when the operator moves his/her finger or the like close to the display screen 110, but also when the operator touches the display screen 110 lightly.

Therefore, even if the operator is not accustomed to the soft keys, he/she can operate them in the similar manner as he/she would press the hard keys halfway. The semi-input process can be performed prior to the input process by moving a finger or the like close to an input button 101 or by lightly touching the input button 101. As a result, the input process can be performed after the operator verifies the type, function, or the like of the input button he/she is about to touch. Consequently, a correct input process can be performed. Also, unlike the disclosures in Patent Documents 2 to 5, input errors that can occur when an operator or an object touches the display screen 110 by mistake can be avoided. In particular, according to Patent Documents 2 to 4, once a semi-input process is performed, an input process is always conducted. However, according to this embodiment, the semi-input process alone can be performed. Therefore, the technology provides high convenience to users.

Also, according to this embodiment, as described above, the individual states discussed above are recognized depending on the light amount entering the light sensors 231 and the contact area on the display screen 110. Therefore, there is no need to conduct the same operation repeatedly as in the technology disclosed in Patent Document 1. As a result, the operability can be improved from the conventional level. Also, because the semi-input functions such as magnification of input buttons 101 and display of descriptions on functions can be performed simply by moving a finger close to or lightly touching the display screen 110, input operation can be conducted in an uninterrupted manner.

According to this embodiment, as shown in FIG. 12, extraction of the number of light sensors 231 receiving the light amount of the second threshold or less (input sensors 234) is conducted prior to the extraction of light sensors 231 receiving the light amount of the first threshold or less (semi-input sensors 233). That is, determination of the inputted state is conducted prior to the determination of the semi-inputted state.

Therefore, in this embodiment, the semi-input process does not necessarily have to be performed. An operator who does not need any description on an input key or who is used to soft keys can press the input button 101 before the semi-input process is performed to conduct only the input process.

That is, according to this embodiment, as described above, it is possible to conduct only the semi-input process, to conduct only the input process, or to conduct the input process after conducting the semi-input process.

According to this embodiment, by appropriately setting, for example, the distance A and the distance B (i.e., light amounts L1 and L2), N, the number of the input sensors 234 and M, the number of the semi-input sensors 233, and the like, a desired process corresponding to the operator's button pressing speed or the like can be conducted. Of course, a desired process corresponding to the operator's button pressing speed and the like can be conducted by appropriately adjusting the time elapses before the semi-input process is initiated using a timer or the like (not shown).

Also, according to this embodiment, as described above, because the above-mentioned states are individually recognized based on the light amount entering the light sensors 231 and the contact area on the display screen 110, the inputted state and the semi-inputted state can be identified from each other even if the pressure of the push is the same in the inputted state and in the semi-inputted state.

Also, according to this embodiment, as described above, because each of the above-mentioned states is recognized based on the light amount entering the light sensors 231 and the contact area on the display screen 110, installation of a separate sensor outside the display panel, as disclosed in Patent Document 5, is not necessary to identify the above-mentioned states.

In the technology disclosed in Patent Document 5, light sensors are provided on the frame surrounding the top surface of the touch panel. However, as described above, if the light sensors are provided outside the display panel, the thickness of the product can be increased and the product design can be restricted. Also, because the light sensors are provided outside the display panel, an additional process becomes necessary. This, together with the requirement for larger amount of parts, increases the manufacturing costs.

In contrast, according to this embodiment, as described above, the above-mentioned states can be identified by using just the light sensors disposed in the liquid crystal panel 200, without any need to install light sensors outside the liquid crystal panel 200 separate from the light sensors 231 disposed inside the liquid crystal panel 200. Therefore, a product featuring a thin profile and light weight can be provided. Also, because no additional sensor parts need to be purchased for installation other than the light sensors 231, increase in the manufacturing time and cost can be avoided.

In this embodiment, light sensors do not necessarily have to be provided outside the liquid crystal panel 200 to recognize the above-mentioned states, but that does not mean that any sensor elements such as light sensors should not be provided outside the liquid crystal panel 200.

As described above, one disadvantage of providing sensor elements such as light sensors outside the liquid crystal panel 200 is increased size of the panel exterior. However, separate sensor elements such as light sensors may be provided outside the liquid crystal panel 200 for a supportive purpose (improvement of S/N ratio, for example).

<Input Process and Semi-Input Process>

Next, the input process and the semi-input process performed by the information processing section 3 are described.

As described above, in this embodiment, different functions are performed in the inputted state and semi-inputted state.

Here, functions associated with the inputted state are, for example, the execution of the input of the touched input button 101. If the input buttons 101 are ten keys, those functions are, for example, entries of numbers or operators corresponding to the touched ten keys, and display of the entries, calculation, and calculation results. If the input buttons 101 are icons, those functions are, for example, launching and running programs represented by the touched icons.

As described above, functions associated with the semi-inputted state are, for example, any functions other than the functions associated with the inputted state of the input buttons 101. Here, the only requirement is that different processing results must be obtainable in the inputted state and in the semi-inputted state. Functions associated with the semi-inputted state are mainly functions other than the execution of the input.

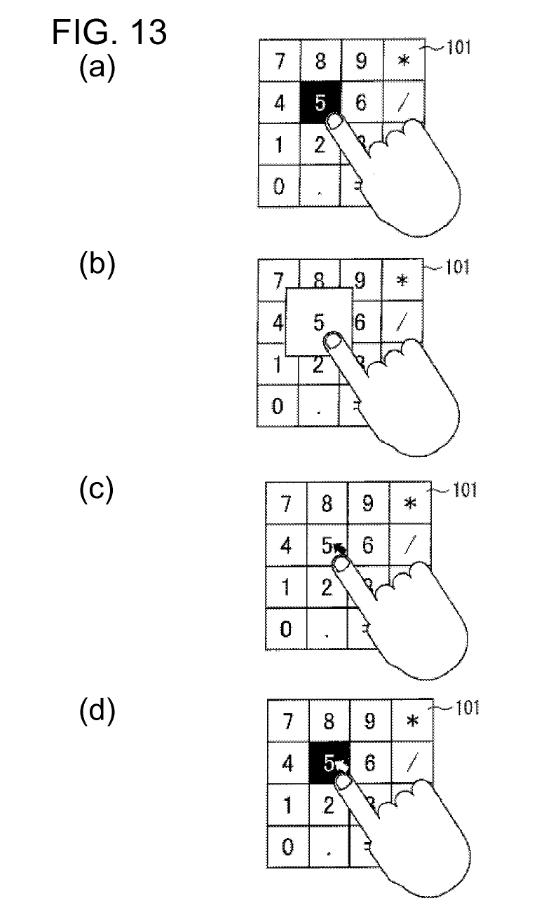

FIG. 13(a) to FIG. 13(d) show examples of the semi-input process.

FIG. 13(a) shows a case where the color of an input button in the semi-inputted state is reversed. FIG. 13(b) shows a case where an input button 101 in the semi-inputted state is magnified. FIG. 13(c) shows a case where a pointer appears in the semi-inputted state. FIG. 13(d) shows a case where the color of an input button 101 in the semi-inputted state is reversed and a pointer appears.

Examples of the semi-input functions include: (a) color reversal or marking of the input button 101 being pointed at; (b) zooming in/out of the input button 101 about to be executed (display enlargement and reduction of, for example, numbers and characters); (c) pointer display for the input button 101 about to be entered; (d) presentation of audio information, written message, or the like associated with the input button 101 about to be entered; and (e) adjustment of the entry impact of the input buttons 101 in game and music instrument applications and the like.

Other examples besides the above-mentioned functions include: (f) half-pressing of the shutter button of the camera (focal point adjustment); and (g) change of focal point of the camera (shift of the focal point framing indicating the focal point).

Here, the input button 101 about to be entered (executed) refers to the input button 101 determined to be in the semi-inputted state by the state determining section 2.

Also, the entry impact adjustment of the input buttons 101 means that in the semi-input process, the input buttons 101 are entered with a softer impact than the impact with which the input buttons 101 are entered in the input process. This way, in a music instrument application, for example, playing with dynamics becomes possible.

The information associated with the input button 101 about to be entered may be the type of the input button 101 about to be entered or further description related to the input button 101 about to be entered.

For example, if the input buttons 101 are ten keys, audio presentation of the information associated with the input button 101 about to be entered may be an audio announcement of the ten key about to be entered. Also, if the input buttons 101 are icons, the audio presentation may be, for example, an announcement of the type of the icon about to be entered, or a detailed description of the function or the like of the icon about to be entered.

If a pointer is configured to be displayed on the display screen 110 as a function associated with the semi-inputted state, the pointer is displayed such that it does not overlap the operator's finger. Also, if a pointer is configured to be displayed on the display screen 110, the pointer may be displayed such that the selection range of the pointer pointing at the input location is reduced as the operator's finger or an object moves closer to the display screen 110.

Also, if the input button 101 about to be executed is configured to be enlarged, the image displayed on the display screen 110 may be configured to be enlarged with a consistent scale with the point of signal input in the semi-inputted state at the center. Alternatively, to allow uninterrupted selection of the input button 101 to be executed, the input button 101 and the surrounding input buttons 101 may be configured to be enlarged when a finger and the like are moved close to the display screen 110 or lightly touches the display screen 110, with the input button 101 of a region of the lowest illuminance in the surrounding region at the center.

Also, depending on, for example, the number of the semi-input sensors 233 and the number of the input sensors 234 that are ON, which are extracted respectively in Step S4 and Step S6, and also depending on the size of the photo current outputted from the semi-input sensors 233 and the input sensors 234 located in the display region of the detected input button 101, the number of the input buttons 101 enlarged may be configured to be reduced as an operator's finger or an object comes closer to the display screen 110.

Thus, examples of the semi-input process include the modification of the display of a certain region including the detected input button 101 such that the region becomes distinguishable from other regions. This way, input locations becomes easy to distinguish or to select.

Also, when the state determining section 2 determines that the detected input button 101 is in the semi-inputted state, it may output different signals to the second information processing section 32 depending on the condition: (A) input button 101 is not touched (within the distance A, but not touched) or (B) the contact area is smaller than the prescribed area. In this case, depending on the condition (A) or (B), the second information processing section 32 performs different semi-input processes for the respective conditions.

Also, depending on the time elapsed after the state determining section 2 determines that the input button is in the semi-inputted state, which time can be measured with a timer or the like, different functions may be configured to be performed. For example, when the semi-inputted state continues for the same input button 101 for more than a prescribed period, the second information processing section 32 may switch the color reversal of the input button 101 to a description display.

Technologies regarding the semi-input processes are known, as disclosed in Patent Documents 1 to 5. Depending on the determination results provided by the state determining section 2, as the semi-input functions performed by the second information processing section, these known semi-input functions may be performed independently, in combination with others, or in addition to others.

Also, in this embodiment, as described above, because the input button can be determined to be in the semi-inputted state if the contact area is smaller than a prescribed area, the display device can have functions obtainable by pressing hard keys halfway.

Therefore, according to this embodiment, semi-input functions such as (e) to (g) described above, which functions are difficult or impossible to perform using conventional soft keys, but obtainable by pressing hard keys halfway, can be performed.

That is, in this embodiment, depending on the determination result provided by the state determining section 2, as the semi-input functions performed by the second information processing section, the known functions obtainable by pressing hard keys halfway may be combined with or added to the above-mentioned semi-input functions.

In the above description of this embodiment, a case where the semi-input sensors 233 are provided separate from the input sensors 234 is used as an example. However, this embodiment is not limited to such.

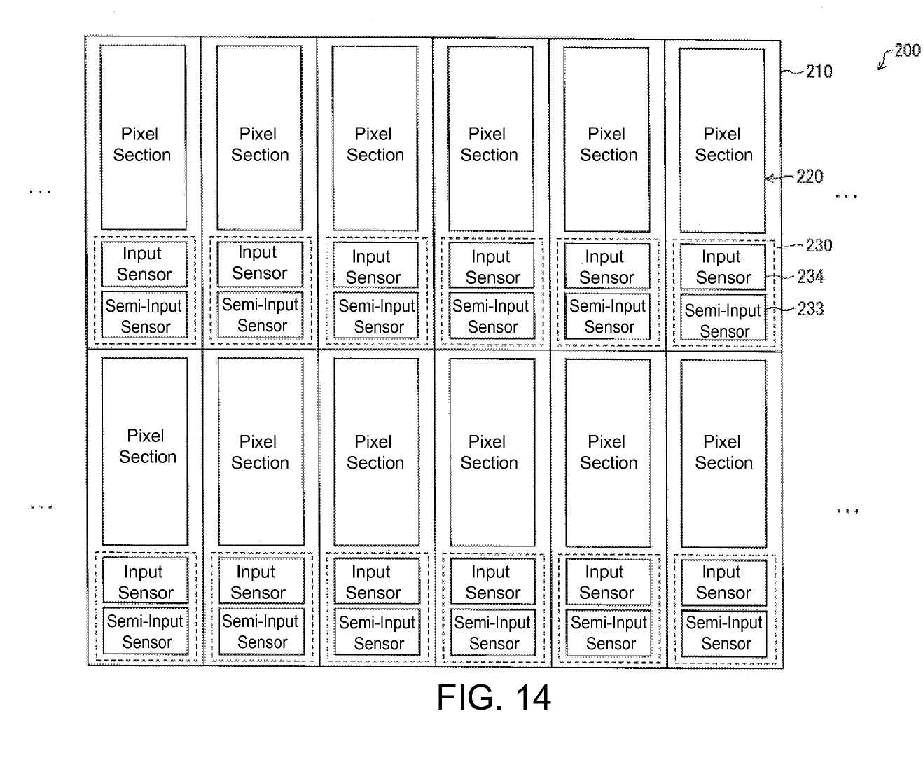

FIG. 14 is another plan view schematically showing the arrangement of the light sensors 231 shown in FIG. 4, where two types of light sensors 231, i.e., the semi-input sensors 233 and the input sensors 234, are used.

In the example shown in FIG. 14, each pixel includes two kinds of light sensors 231, which are a semi-input sensor 233 and an input sensor 234. In this case, as shown in FIG. 14, pixels 210 are formed in an identical pattern.

With two light sensors 231 in each pixel, which are a semi-input sensor 233 and an input sensor 234, the resolution of the light sensor 231 can be improved.

Also, by mixing pixels 210 each including one light sensor 231, which is either a semi-input sensor 233 or an input sensor 234 as shown in FIG. 6, and pixels 210 each including two light sensors 231, which are a semi-input sensor 233 and an input sensor 234, reduction in transmittance can be suppressed and the resolution of the light sensors 231 can be improved.

In the above description of this embodiment, a case where two kinds of light sensors 231 (the semi-input sensor 233 and the input sensor 234) having different thresholds for turning the sensing ON is used as an example. However, this embodiment is not limited to such.

For example, a conventional light sensor may be used as the light sensor 231, and whether the state is the non-inputted state, the halfway-pressed state, or the inputted state may be determined by the state determining section 2 based on the comparison operation of the received light amount of the light sensor 231, the first threshold (L1), and the second threshold (L2). That is, the above-mentioned states may be identified by the comparison operation of the photo current value outputted based on the light amount received at the light sensor 231, the photo current values outputted when the light amount received at the light sensor 231 is equal to the first threshold (L1), and when the light amount received at the light sensor 231 is equal to the second threshold (L2).

In this case, the light sensor may be determined to be in OFF state (non-inputted state) when distance Q>distance A (i.e., received light amount>L1); the semi-input sensor may be determined to be in ON state when distance A≧distance Q>distance B (i.e., L1≧received light amount>L2); and the input sensor may be determined to be ON state when distance B≧distance Q (i.e., L2≧received light amount).

In the above description of this embodiment, a case where the display device is a portable phone is used as an example. However, the display device is not limited to a portable phone. The present invention is applicable to a variety of display devices where a display section and an input section are combined, and also to electronic devices including such display devices.

Examples of these display devices and electronic devices include various mobile terminals such as portable phones, PHS (Personal Handyphone System), and PDA (Personal Digital Assistants). The above-mentioned display device is also suitably applicable to, for example, car mounted navigation device, audio devices, DVD (Digital Versatile Disc) players, television devices, game devices, music player devices, and hybrid electronic devices where functions of these devices are combined.

In the description of this embodiment, a case where a display panel including a touch panel as an integrated part is used as the display section 11. However, this embodiment is not limited to such. A display panel and a touch panel disposed over the display panel may also be used.

Also in the description of this embodiment, a case where a liquid crystal panel is the display panel is discussed as an example. However, this embodiment is not limited to such. The display panel may be, for example, a display panel using electroluminescence (EL). That is, the display device of this embodiment is not limited to a liquid crystal display device. It may be an EL display device or the like.

If a liquid crystal panel having features such as a thin profile and light weight is used as the display panel, the display panel becomes more portable.

As described above, the above-mentioned display device is configured to include: a display panel that displays input buttons on the display screen; a state determining section that determines that an input button is in the inputted state when an operator's finger or an object is in contact with the input button with a contact area that is at least as large as a prescribed area, determines that an input button is in the semi-inputted state if an operator's finger or an object is in contact with the input button with a contact area that is smaller than the prescribed area, or if the distance from an operator's finger or an object to an input button in the normal direction is equal to or smaller than a prescribed distance and the finger or the object is not in contact with the input button, and determines that an input button is in the non-inputted state if a finger or an object is away from the input button more than the prescribed distance in the direction normal to the input button; and an information processing section that performs functions associated with state of the input button determined by the state determining section.

More specifically, the display device includes light sensors in the display panel for every pixel, and the state determining section determines that an input button is in the semi-inputted state when the number of the light sensors that are located in a region associated with the input button including the coordinates of the operator's finger or the object and that are receiving light amount of L1 or less is at least M (0<M), and the number of light sensors that are located in the above-mentioned region and are receiving light amount of L2 or less is less than N (0<N); and determines that the input button is in the inputted state when the number of light sensors that are located in the above-mentioned region and are receiving light amount of L2 or less is at least N, where L1 is the light amount received by the light sensor when the distance from the operator's finger or the object to the input button in the normal direction is equal to the prescribed distance, and L2 is the light amount received by the light sensor when the operator's finger or the object is in contact with the display screen with a contact area that is at least as large as the prescribed area.

The information processing section performs a function associated with the semi-inputted state of the input button when the number of light sensors that are located in a region associated with the input button including the coordinates of the operator's finger or the object on the display screen, and that are receiving the light amount of L1 or less is at least M. The information processing section also performs the function associated with the inputted state of the input button when the number of light sensors that are located in the region associated with the input button whose semi-input function is being performed and that are receiving light amount of L2 or less is at least N.

According to the configurations described above, the above-mentioned states can be identified from the light amount received by the light sensors disposed in the display panel and the contact area between the operator's finger or an object and the display screen. As a result, the above-mentioned states can be determined without any need to install light sensors outside the display panel. Therefore, a product featuring a thin profile and light weight can be provided. Also, because no additional sensor parts need to be purchased for installation other than the above-mentioned light sensors, increase in the manufacturing time and cost can be avoided.

Preferably, the display device includes, as the light sensors, input sensors for determining that the received light amount is L2 or less, and semi-input sensors for determining that the received light amount is L1 or less, and also preferably only either the input sensor or the semi-input sensor is disposed in each pixel.

According to the configuration described above, because only either a semi-input sensor or an input sensor is provided in each pixel, the transmittance can be maintained at about the same level as conventional display panels. Also, the above-mentioned liquid crystal panel can be manufactured without increasing the number of manufacturing processes of the conventional display panels having light sensors disposed therein. The above-mentioned display device, therefore, can be manufactured without increasing the takt time or the cost.

Preferably, the above-mentioned display device includes, as the light sensor, an input sensor for determining that the received light amount is L2 or less and a semi-input sensor for determining that the received light amount is L1 or less in each pixel.

According to the configuration described above, because both the input sensor and the semi-input sensor are provided in each pixel, the resolution of the light sensor can be improved.

Preferably, the display device includes, as the above-mentioned light sensors, an input sensor for determining that the received light amount is L2 or less, and a semi-input sensor for determining that the received light amount is L1 or less. Also, the display device preferably includes pixels each including only either one of the input sensor or the semi-input sensor, and pixels each including an input sensor and a semi-input sensor, which are mixed in the arrangement.

According to the configuration described above, reduction in transmittance can be suppressed and the resolution of the light sensor can be improved.

The present invention is not limited to embodiments described above. Various modifications can be made within the scope defined by the appended claims, and embodiments that can be obtained by combining technological features disclosed in different embodiments are also included in the technological scope of the present invention.

### INDUSTRIAL APPLICABILITY

The present invention can suitably be used for display devices with a touch panel function and electronic devices using such display devices. Examples include: various mobile terminals, car mounted navigation devices, audio devices, DVD (Digital Versatile Disc) players, television devices, game devices, music player devices, and hybrid type electronic devices where functions of these devices are combined.

### DESCRIPTION OF REFERENCE CHARACTERS

1 control section
2 state determining section
3 information processing section
4 function performing section
11 display section
12 audio output section
13 imaging section
14 sensor section
15 storage section
16 antenna section
17 communication section
21 pixel
31 first information processing section
32 second information processing section
41 display processing section
42 audio processing section
43 imaging processing section
100 portable phone
101 input button
110 display screen
200 liquid crystal panel
210 pixel
220 pixel section
230 sensor section
231 light sensor
233 semi-input sensor
234 input sensor

1. A display device comprising:
a display panel that displays input buttons on a display screen;
a state determining section that determines a button to be in an inputted state when an operator's finger or an object is in contact with the input button with a contact area that is at least as large as a prescribed area, that determines the input button to be in a semi-inputted state when the operator's finger or the object is in contact with the input button with a contact area smaller than the prescribed area or when the distance between the operator's finger or the object and the input button in a normal direction is no greater than a prescribed distance and the finger or the object is not in contact with the input button, and that determines the input button to be in a non-inputted state when the operator's finger or the object is away from the input button by a distance greater than the prescribed distance in the normal direction; and
an information processing section that performs a function associated with the individual states of the input button, according to the state determined by said state determining section.

2. The display device according to claim 1, further comprising light sensors in said display panel for each pixel,
wherein said state determining section determines that an input button is in the semi-inputted state when the number of light sensors that are located in a region associated with the input button including coordinates of the operator's finger or the object and that are receiving light amount of L1 or less is at least M (0<M), and the number of light sensors that are located in said region and are receiving light amount of L2 or less is less than N (0<N); and determines that the input button is in the inputted state when the number of light sensors that are located in said region and that are receiving light amount of L2 or less is at least N, where L1 is the light amount received by the light sensor when the distance from the operator's finger or the object to the input button in the normal direction is equal to said prescribed distance, and L2 is the light amount received by the light sensor when the operator's finger or the object is in contact with the display screen with a contact area that is at least as large as said prescribed area.

3. The display device according to claim 2,
wherein said information processing section performs a function associated with the semi-inputted state of the input button when the number of light sensors that are located in a region associated with the input button including the coordinates of the operator's finger or the object on the display screen and that are receiving the light amount of L1 or less is at least M, and performs the function associated with the inputted state of the input button when the number of light sensors that are located in the region associated with the input button whose semi-input function is being performed and that are receiving light amount of L2 or less is at least N.

4. The display device according to claim 2, comprising an input sensor for determining whether the received light amount is L2 or less and a semi-input sensor for determining whether the received light amount is L1 or less, as said light sensor,
wherein either one of said input sensor or said semi-input sensor is disposed in each pixel.

5. The display device according to claim 2, wherein, an input sensor for determining whether the received light amount is L2 or less and a semi-input sensor for determining whether the received light amount is L1 or less are disposed in each pixel as said light sensor.

6. The display device according to claim 2, comprising an input sensor for determining whether the received light amount is L2 or less, and a semi-input sensor for determining whether the received light amount is L1 or less, as said light sensor,
wherein pixels each including only either one of the input sensor or the semi-input sensor, and pixels each including an input sensor and a semi-input sensor are mixed in an arrangement.
